(19) United States
(12) Patent Application Publication
(10) Pub. No.: US 2026/0003717 A1
(43) Pub. Date: Jan. 1, 2026

(54) DRAM FAULT ANALYZER

(71) Applicant: ADVANCED MICRO DEVICES, INC., Santa Clara, CA (US)

(72) Inventor: Kun Tan, Shanghai (CN)

(21) Appl. No.: 18/756,106

(22) Filed: Jun. 27, 2024

(51) Int. Cl. G06F 11/07

(52) U.S. Cl. CPC G06F 11/0787; G06F 11/073; G06F 11/0793

(57) ABSTRACT

A processing system identifies both the types of errors detected at a memory and the severity of the errors. The processing system keeps track of errors in error logs. The processing system employs a fault analyzer to generate, based on the error logs, a recommended management solution for one or more of the detected errors.

### BACKGROUND

Memory errors at a processing system, such as memory storage errors that result in missing data or damaged data, can cause a system interrupt or a system failure depending on the severity of the error. To mitigate these errors, a processing system can include memory (e.g., dynamic random-access memory (DRAM)) that has error detection and correction capabilities. For example, some processing systems employ error correction codes (ECC) and error correction circuitry (EC) to detect errors and reconstruct missing data based on the ECC. Generally, the EC stores ECC codes with data words and uses the codes to determine whether an error has occurred among the ECC codes and the data words during a read or a write operation. To correct errors detected by the EC, some processing systems employ a graphics processing unit (GPU) to identify a fault management strategy according to a fault mode (i.e., a portion of memory affected by the error). The fault management strategy includes procedures for resolving the error in the DRAM.

Under conventional solutions, fault management is strictly based on detection of the error and does not account for potential future problems, such as hardware failure. In at least some cases, this approach prolongs usage of the DRAM despite a high likelihood of decline in operational portions of the DRAM. For example, in some systems the firmware and/or the driver of the GPU resets the GPU in response to detecting an error, and retires the corresponding memory page in the DRAM by redirecting use of an unusable area of the DRAM (i.e., portion of memory where the ECC detected the error) to a useable area of the DRAM (i.e., portion of memory where no errors have been detected). Over time, this process is repeated until the number of unusable areas of the DRAM exceeds a threshold, requiring replacement of the DRAM completely. However, this approach does not differentiate between a single-row fault and a multi-row fault, which can result in retiring a larger amount of memory than necessary to resolve the problem.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some embodiments.

FIG. 2 is a block diagram illustrating aspects of a fault analyzer module of FIG. 1 in accordance with some embodiments.

FIG. 3 is a diagram illustrating different examples of fault management by a fault analyzer module of FIG. 1 based on a fault mode in accordance with some embodiments.

FIG. 4 is a flow diagram illustrating a method for examining memory banks identified with errors in error logs in accordance with some embodiments.

FIG. 5 is a block diagram of a processing system that employs fault analyzer circuitry to generate a recommended management solution for errors detected at a memory in accordance with some embodiments.

### DETAILED DESCRIPTION

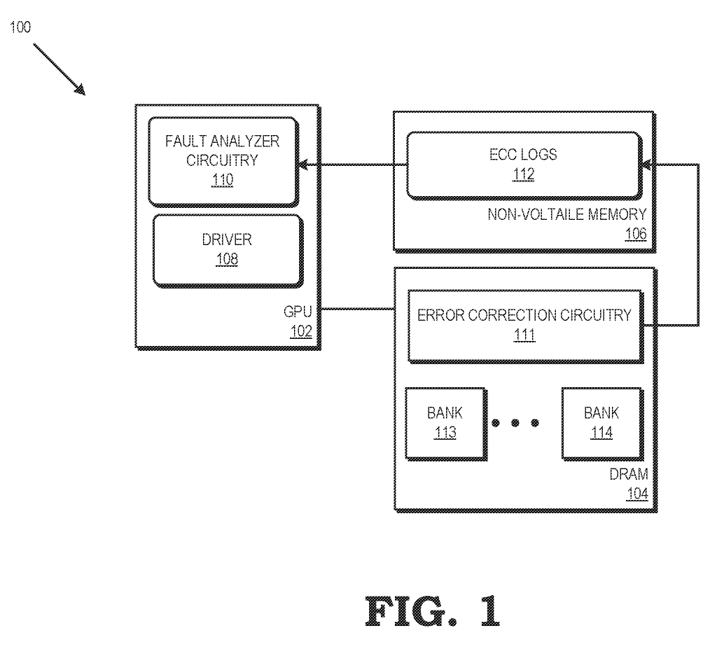

FIGS. 1-5 illustrate techniques for analyzing and managing errors in a memory device of a processing system, such as dynamic random-access memory (DRAM). Memory errors occur due to physical defects in the DRAM (e.g., a memory location, address), software defects (e.g., incorrect data written to the DRAM during a write operation or read from the DRAM during a read operation), operating system defects (e.g., poor memory management, memory leaks), and the like. While software defects and operating system defects are repairable through software updates, physical defects cannot typically be repaired by the system itself.

Furthermore, the severity of the errors varies widely and depends on how much of the DRAM is affected by the errors. For example, in some cases a single-bit fault is located at a single cell in memory. To correct the error, the DRAM employs error correction circuitry (EC) that uses an error correction code (ECC) to replace an incorrect value (i.e., an incorrect bit) to the correct value (i.e., a correct bit) using a bit. However, other errors are more serious, such as a two-column fault. In this case, multiple rows of the DRAM are affected by the error. These types of errors are generally uncorrectable and will result in a system error during a read and/or a write operation (hereinafter referred to as memory access operations).

Using the techniques described herein, a processing system identifies both the types of errors detected by EC in a DRAM and the severity of the errors and records the errors in error logs. The error logs store information indicative of each error detected by the DRAM during memory access operations, as well as the address where the errors occurred. In order to mitigate errors in the DRAM and identify an error management solution that avoids substantial impact to the processing system, the processing system employs a fault analyzer to generate a recommended management solution for one or more of the detected errors, as described further below. For purposes of description, the embodiments described below are described with respect to a fault analyzer that is implemented in hardware and is therefore referred to as fault analyzer circuitry. However, in other embodiments the fault analyzer is implemented in software.

In response to detection of one or more errors by the EC, the fault analyzer circuitry checks the errors logs to identify specific portions of the DRAM where errors were detected. Moreover, the fault analyzer circuitry checks each memory bank in the DRAM to determine the extent of the errors. Once all the memory banks of the affected DRAM have been identified from the error logs, the fault analyzer circuitry classifies the fault mode of the DRAM based on a type and a number of the errors. Based on collecting the type of and the number of errors, the fault analyzer circuitry generates a recommended the solution for fault management of the DRAM. Stated differently, the number of errors indicate one or more addresses in the DRAM where errors occurred, and the type of the errors indicate the severity of the errors. Accordingly, for example, in some embodiments the fault analyzer circuitry recommends page retirement for minor errors, and recommends hardware replacement for severe errors (e.g., multiple errors in multiple addresses of the DRAM).

Under conventional fault management, a typical solution to the majority of fault modes is to simply retire the bad page. Retiring the bad page enables the DRAM to continue operation by using a different and still functioning page. In contrast, using the techniques described herein, the fault analyzer circuitry analyzes the severity of the faults in the DRAM by examining an entire memory bank. Based on the examination, the fault analyzer circuitry predicts the extent of the damage to the DRAM and stores a recommended management solution based on the fault mode identified during the examination. In some cases, these stored recommended management solutions are reviewed and implemented by a system repair engineer. In this manner, the fault analyzer circuitry reduces service disruption and improves uptime of the processing system. Furthermore, the fault analyzer circuitry reduces mean time to failure (MTTF) of the processing system.

FIG. 1 illustrates a block diagram of a processing system 100 in accordance with some embodiments. The processing system 100 is generally configured to execute sets of instructions (e.g., computer programs) in order to carry out operations, as specified by the sets of instructions, on behalf of an electronic device. Accordingly, in different embodiments, the system 100 is part of any one of electronic devices, such as a desktop computer, a laptop computer, a server, a smartphone, a tablet, a game console, and the like.

In order to execute instructions, the processing system 100 includes a graphics processing unit (GPU) 102, a DRAM 104, and a non-volatile memory (NVM) 106. In the depicted example, the GPU 102 is a single GPU and the DRAM 104 is a single DRAM. However, it will be appreciated that in other embodiments, the processing system 100 includes more GPUs and more DRAMs. In addition, in other embodiments, the processing system 100 includes additional circuitry not illustrated in FIG. 1 that supports the execution of instructions, such as a central processing unit (CPU), one or more memory controllers, one or more input/output controllers, one or more input/output devices, and the like, or any combination thereof. In some embodiments, the GPU 102 and the DRAM 104 are part of the same integrated circuit (IC) package but are incorporated in separate IC dies.

The GPU 102 is generally configured to execute sets of instructions for the processing system 100. In some embodiments, the GPU 102 includes one or more processor cores, wherein each processor core includes one or more instruction pipelines. Each instruction pipeline includes circuitry configured to fetch instructions from a set of instructions assigned to the pipeline, decode each fetched instruction into one or more operations, execute the decoded operations, and retire each instruction one the corresponding operations have completed execution.

To direct operations of the GPU 102, in various embodiments, the CPU executes a driver 108. The driver 108 is a software application that facilitates rendering of graphics by the processing system 100. For example, in some embodiments, the GPU 102 receives commands from the CPU, decodes those commands and executes the decoded commands to carry out operations on behalf of the CPU.

Additionally, the driver 108 is configured to perform interrupt handling with regard to errors during operation by the GPU 102. For example, in various embodiments, the driver 108 executes an interrupt handler that triggers a hardware reset in response to an error based on bad data (e.g., a memory request to the DRAM 104 that returned the wrong value or was unable to respond to the memory request).

The GPU 102 employs fault analyzer circuitry 110 to identify errors occurring in memory during a memory access operation. Examples of such errors include read errors, which occur when the DRAM 104 fails to properly respond (i.e., retrieve) to a read request for data by the GPU 102. More specifically, read errors by the DRAM 104 are, for example, the result of a physical defect of the DRAM at the time of manufacture, memory cells that have lost storage capability due to usage, and/or incorrect values stored at a memory location (also referred to herein as a memory address or simply an address). For example, in some cases a read error occurs when the DRAM 104 with a defective memory cell fails to return the data to the GPU 102 in response to the read request. In this case, the failure of the DRAM 104 to return the data is the result of inability to read the address where the data is located due to physical defect at the time of manufacture, or the memory location is no longer capable of retrieving the data. Alternatively, and/or in addition thereto, in some cases the DRAM 104 returns the data, but the data is not the data requested by the GPU 102 due to incorrect data stored at the address of the DRAM 104. In all cases, the read error by the DRAM 104 results in an error at the processing system 100. Depending on the importance of the data, it may be a minor error or a major error. As will be explained below, the severity of the error affects how the processing system 100 operates.

Another type of error occurring in the DRAM 104 is based on a write operation. Specifically, a write error occurs where the DRAM 104 fails to properly store (i.e., write) the data at a particular address for the GPU 102. More specifically, the basis for write errors by the DRAM 104 are similar to the basis for read errors. That is, write errors are the result of a physical defect at the time of manufacture, memory cells that have lost storage capability due to usage, and/or incorrect values stored at the memory location. For example, the DRAM 104 with a defective memory cell fails to store the data to the GPU 102 in response to the write request. In this case, the failure of the DRAM 104 to store the data is the result of inability to write to the address where the data is located due to physical defect at the time of manufacture, or the memory location is no longer capable of storing the data. Alternatively, and/or in addition thereto, the DRAM 104 stores the data, but the data is not the data required by the GPU 102 to be stored. In all cases, the write error by the DRAM 104 results in an error to the processing system 100. For example, the error of the processing system 100 includes termination of further processing by the GPU 102 to write the data and/or shutting down of the GPU 102 based on the severity of the error. Depending on the importance of the data, it may be a minor error or a major error. As will be explained below, the severity of the one or more errors affects how the processing system 100 operates.

In various embodiments, the DRAM 104 includes error correction circuitry 111 (EC) that employs error correction code (ECC) to detect and correct errors in the DRAM 104. The DRAM 104 includes at least one parity bit or at least one check bit for error detection. The EC 111 detects the read errors and/or the write errors and reports the errors to the GPU 102. The EC 111 stores the at least one parity bit when storing data. To detect the errors, the EC 111 checks the data to see if the stored data and the at least one parity bit matches the data that was stored. Accordingly, if there are incorrect number of bits including the at least one parity bit, then the EC 111 detects the errors. In response to receiving indication (e.g., reports by the EC 111) of the one or more errors, the GPU 102 retrieves one or more errors logs 112 from the DRAM 104 and stores the one or more errors in the one or more ECC logs 112 on the NVM 106. In some embodiments, the NVM 106 includes an electrically erasable programmable read-only memory (EEPROM), a flash memory, hard disk, optical discs, and the like. To illustrate, the GPU 102 makes a request to the DRAM 104 for rendering graphics in a software application. A portion of graphics data is located in a row where a single bit contains an incorrect value. During the read operation, the EC 111 detects the read error and corrects the single bit by replacing the incorrect value with a correct value. The EC 111 identifies this error as a correctable error. In this manner, the EC 111 prevents erroneous data from being used by processing system 100. The EC 111 records the error in the one or more ECC logs 112. In the aforementioned example, the read error was a minor error that caused no interruption to the processing system 100.

To illustrate a major error, as before, the GPU 102 makes a request to the DRAM 104 for rendering graphics in a software application. However, unlike the previous example, a portion of the required graphics data is located in multiple rows and multiple columns where each row and each column contain an incorrect value and/or have physical defects. During the read operation, the EC 111 detects the read error, but cannot correct the error because multiple memory locations in the DRAM 104 have errors. Accordingly, the EC 111 identifies these errors as uncorrectable errors in the one or more ECC logs 112. In the aforementioned example, the read error is a major error that caused interruption to the processing system 100 because the error is not correctable. In response to the failure to retrieve the requested data, the processing system 100 is disrupted, which could cause execution errors at the GPU 102 and/or other errors with the rest of the processing system 100. As highlighted above, a minor error is an error that does not interrupt the processing system 100. In such a situation, a management solution, such as logging the error is appropriate, for the minor error because the minor error is unlikely to result in more errors that impact the processing system 100. Conversely, a major error does interrupt the processing system 100. That is, the management solution, such as resetting the GPU 102 is appropriate for the major error because the major error is likely to prevent the processing system 100 from continuous, successful operation.

In some embodiments, in response to an error, the fault analyzer circuitry 110 collects all the errors recorded in the one or more ECC logs 112 on the NVM 106. In some embodiments, the fault analyzer circuitry 110 collects all the errors periodically. The fault analyzer circuitry 110 decodes the one or more ECC logs 112 to specifically identify one or more addresses and/or one or more memory banks 113, 114 in the DRAM 104 where the one or more errors occurred. In some embodiments, the fault analyzer circuitry 110 decodes the one or more addresses into a channel, a bank, a row of the one or more memory banks 113, 114, or any combination thereof. In some embodiments, the fault analyzer circuitry 110 uses a system kernel to decode the one or more addresses. After decoding the one or more ECC logs 112, the fault analyzer circuitry 110 begins examining the one or more decoded addresses of the memory banks 113, 114 containing the one or more errors. The fault analyzer circuitry 110 tests the memory banks 113, 114 based on the one or more addresses identified in the one or more ECC logs 112. In some embodiments, to test the memory banks 113, 114, the fault analyzer circuitry 110 initiates a memory access operation for each row in the memory banks 113, 114. Subsequently, the fault analyzer circuitry 110 logs any error encountered and confirmed to be an ECC error. Also, the fault analyzer circuitry 110 clears the memory bank 113 or 114. The fault analyzer circuitry 110 continues the aforementioned procedure until examination of the entire memory bank 113 or 114 is completed. Accordingly, the fault analyzer circuitry 110 repeats the process for each other memory bank that was identified to have the one or more errors in the one or more ECC logs 112. It will be appreciated that while only two memory banks 113 and 114 are depicted in FIG. 1. In other embodiments, there are more than two memory banks.

While the fault analyzer circuitry 110 reviews the one or more ECC logs 112, the driver 108 resets the GPU 102 to prevent the one or more errors from interfering with additional operations of the GPU 102 and the fault analyzer circuitry 110 prevents any interrupt handlers of the GPU 102 from responding to additional errors. In this manner, the fault analyzer circuitry 110 reduces likelihood of the GPU 102 from performing additional operations, and specifically, performing operations on errors that affect the entirety of the processing system 100.

After the fault analyzer circuitry 110 completes examination of the memory banks 113, 114 identified to have the one or more errors, the fault analyzer circuitry 110 organizes the data. Specifically, the fault analyzer circuitry 110 classifies a type of fault mode for the memory banks 113, 114 based on a number of errors identified during examination and/or address within the memory banks 113, 114. In various embodiments, the type of fault modes include a single-bit fault, a single-word fault, a single-column fault, a two-column fault, a partial-row fault, a single-row fault, a single-row-plus-single-bit fault, a two-row fault, a consecutive-row fault, a cluster-row fault, a single-bank fault, a quarter-device fault, a half-device fault, a full-device fault, a single-pin fault, a single-lane fault, and/or any combination thereof. The single-bit fault is a fault in the DRAM 104 that affects a single DRAM 104 cell. The single-word fault is a fault that affects multiple bits in the single DRAM 104 word. The two-column fault is a fault that affects two columns in a bank spanning multiple rows. The partial-row fault is a fault that affects between two and one-hundred twenty-eight (128) columns in a row. The single-row fault is a fault that affects between 128 and one-thousand twenty-four (1024) columns in a row. The single-row-plus-single-bit fault is a fault that affects a single row plus an additional bit in the same memory bank, which is usually within a few rows of the fault row. The two-row fault is a fault that affects two rows in the same memory bank, which are usually close together but not adjacent. The consecutive-row fault is a fault that affects four or eight consecutive rows in a single memory bank. The cluster-row fault is a fault that affects multiple clusters of rows in a memory bank. The single-bank fault is a fault that affects multiple rows in a memory bank, which is usually more than a quarter of all rows. The quarter-device fault is a fault that affects four banks in the DRAM 104. The half-device fault is a fault that affects between five and eight banks in the DRAM 104. Moreover, the half-device fault usually affects portions of each bank. The full-device fault is a fault that affects between nine and sixteen banks in the DRAM 104. Also, the full-device fault affects at least half of the bits in each bank. The single-pin fault is a fault that affects a single DQ pin (i.e., pin implemented on a D flip-flop, where D is the input and Q is the output) that occurs across all ranks on that pin. Finally, the single-lane fault is a fault that affects a single lane but occurs across all ranks on that lane. It will be appreciated that in other embodiments, there may be more or less types of faults than described herein, or a given fault described above may affect more or fewer bits, banks, rows, or pins.

After the fault analyzer circuitry 110 has organized and classified the data, the fault analyzer circuitry 110 predicts an impact of the one or more errors to operation of the DRAM 104. Stated differently, the fault analyzer circuitry 110 determines a likelihood of future errors (i.e., a failure rate) based on the types of fault identified for each of the memory banks 113, 114 that was examined. In some embodiments, the failure rate is a specified set of data specified by a manufacturer based on occurrence of fault mode on other memory devices. The specified set of data is stored at the NVM 106 for access by the fault analyzer circuitry 110. In different embodiments, the failure rate is predicted by an artificial intelligence (AI) engine, machine learning engine, and the like. For example, the AI engine is trained to predict the failure rate over time based on the type of fault. As such, the fault analyzer circuitry 110 generates a solution or a policy to fix the fault mode that is stored in the NVM 106 for subsequent access by the GPU 102 and/or the fault analyzer circuitry 110. That is, the fault analyzer circuitry 110 indicates what procedures are taken based on the fault mode.

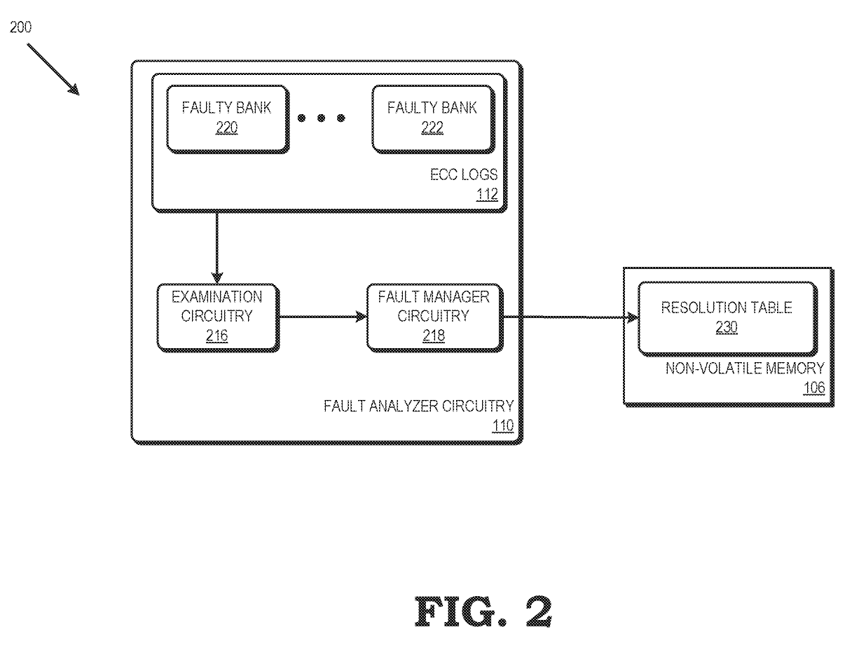

FIG. 2 illustrates a block diagram illustrating aspects of the fault analyzer circuitry 110 of FIG. 1 in accordance with some embodiments. In the depicted example, the fault analyzer circuitry 110 includes an examination circuitry 216 and a fault manager circuitry 218.

After the GPU 102 retrieves the errors recorded in the one or more ECC logs 112 from the NVM 106, the examination circuitry 216 decodes the one or more ECC logs 112 to identify the one or more addresses and/or the one or more memory banks 113, 114 in the DRAM 104 where the errors occurred. Based on the one or more ECC logs 112, the examination circuitry 216 identifies the one or more memory banks 113, 114 that have errors as, for example, a faulty bank 220 and a faulty bank 222, respectively. In other words, in the aforementioned example, the faulty bank 220 corresponds to the memory bank 113 and the faulty bank 222 corresponds to the memory bank 114. However, in other cases, the faulty bank 220 and the faulty bank 222 correspond to any of the memory banks within the one or more ECC logs 112 that were identified to have errors. Once the one or more ECC logs 112 have been decoded the examination circuitry 216 begins examination. The examination circuitry 216 tests the faulty bank 220 and the faulty bank 222 based on the one or more addresses identified in the one or more ECC logs 112 as having one or more errors. Specifically, the examination circuitry 216 initiates a memory access operation for each row in the faulty bank 220 and the faulty bank 222. The examination circuitry 216 passes along the results of the memory access operation to the fault manager circuitry 218.

In response to receiving the results of the memory access operation examination circuitry 216, the fault manager circuitry 218 logs any error encountered to be stored as a resolution table 230 on the NVM 106. The fault manager circuitry 218 organizes the errors in the resolution table 230 upon completion of examination by the examination circuitry 216. The fault manager circuitry 218 classifies the type of fault mode for the faulty bank 220 and the faulty bank 222 based on the number of errors identified during examination and/or the address where the one or more errors occurred within the faulty bank 220 and the faulty bank 222. For example, the examination circuitry 216 locates the one or more errors in different portions of a single column of the faulty bank 220. Based on the errors identified by the examination circuitry 216, the fault manager circuitry 218 classifies the fault mode as a single-column fault. The fault manager circuitry 218 determines the likelihood of future errors based on the types of fault identified for the faulty bank 220 and the faulty bank 222. In some embodiments, the fault management circuitry 218 determines the likelihood of future errors from the NVM 106, such that the likelihood of future errors is a fixed, predetermined number (e.g., percentage) based on testing before manufacture. In other embodiments, the fault management circuitry 218 determines the likelihood of future errors based on an artificial intelligence (AI) engine, machine learning engine, and the like. For example, the AI engine is trained to determine the likelihood of future errors over time based on occurrence of error. As such, the fault manager circuitry 218 generates a solution that is stored in the NVM 106 to fix the fault modes corresponding to the faulty bank 220 and the faulty bank 222.

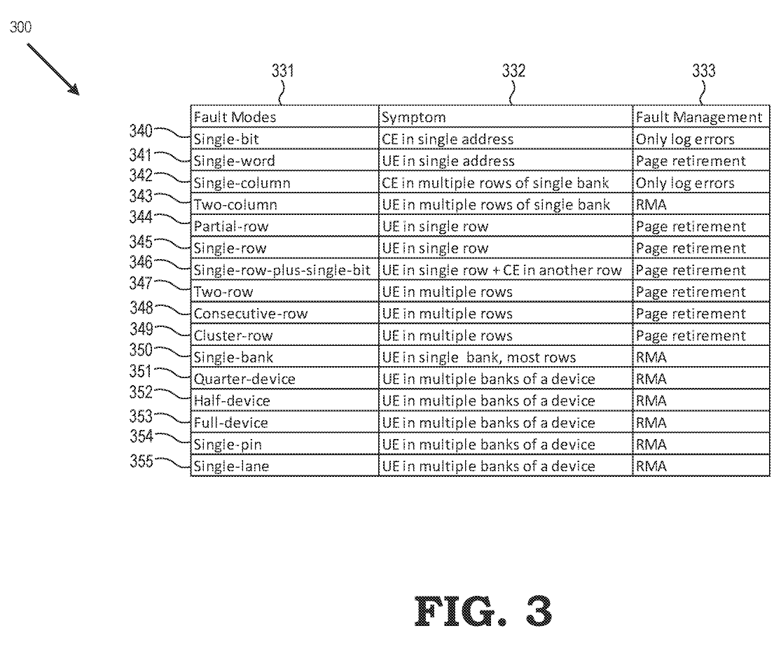

FIG. 3 illustrates a table 300 depicting an example of the resolution table 230 of FIG. 2 as determined by the fault manager circuitry 218. The table 300 includes three columns, designated columns 331-333, corresponding to different features of the one or more errors identified in the faulty bank 220 or the faulty bank 222. Specifically, column 331 identifies the type of fault modes. On the other hand, column 332 identifies the symptoms exhibited by the error and what portion of the memory bank is affected. The column 333 identifies the solution (i.e., the recommended management solution) to fix the fault modes corresponding to the faulty bank. Additionally, the table 300 includes seventeen rows, with a top row indicating headings for the columns, and the remaining sixteen rows, designated rows 340-355, corresponding to different results based on the fault mode. Specifically, the row 340 identifies the single-bit fault. The row 341 identifies the single-word fault. The row 342 identifies the single-column fault. The row 343 identifies the two-column fault. The row 344 identifies the partial-row fault. The row 345 identifies the single-row fault. The row 346 identifies the single-row-plus-single-digit fault. The row 347 identifies the two-row fault. The row 348 identifies the consecutive-row fault. The row 349 identifies the cluster-row fault. The row 350 identifies the single-bank fault. The row 351 identifies the quarter-device fault. The row 352 identifies the half-device fault. The row 353 identifies the full-device fault. The row 354 identifies the single-pin fault. The row 355 identifies the single-lane fault.

The following examples described herein are applicable to the memory bank 113 or 114 depending on the results found during examination by the fault analyzer circuitry 110. For the single-bit fault, at the row 340, the fault examination circuitry 216 determined the memory bank 113 had a single-bit fault. The fault examination circuitry 216 also identified the memory bank 113 had a correctable error (CE) at a single address. The examination circuitry 216 determines the ECC of the DRAM 104 was able to correct the error. Therefore, the fault management circuitry 218 only logs the error in the resolution table 230.

With respect to the single-word fault, at the row 341, the fault examination circuitry 216 determined the memory bank 113 had a single-word fault. Unlike the previous example, the fault examination circuitry 216 identifies the memory bank 113 has an uncorrectable error (UE) at a single address. The examination circuitry 216 determines the ECC of the DRAM 104 was unable to correct the error. Therefore, the fault management circuitry 218 identifies page retirement in the resolution table 230. That is, the fault management circuitry 218 indicates to the DRAM 104 to redirect use of future memory access operations to a different and still operational area of the DRAM 104.

With respect to the single-column fault, at the row 342, the fault examination circuitry 216 determined the memory bank 113 had a single-column fault. The fault examination circuitry 216 identifies the memory bank 113 has CEs in multiple rows. The examination circuitry 216 determines the EC 111 was able to correct the one or more errors. Therefore, the fault management circuitry 218 only logs the one or more errors in the resolution table 230.

With respect to the two-column fault, at the row 343, the fault examination circuitry 216 determined the memory bank 113 had a two-column fault. Unlike the previous example, the fault examination circuitry 216 identifies the memory bank 113 has UEs in multiple rows. The examination circuitry 216 determines the EC 111 was unable to correct the one or more errors. The fault management circuitry 218 determines the two-column fault exceeds a severity threshold to warrant a replacement (e.g., a return merchandise authorization, RMA). The severity threshold is a measure of how severe the one or more errors are within the memory bank 113. Moreover, the severity threshold identifies the severity of the defects (e.g., physical, software) that prevents likelihood of future successful operations within portions of the memory bank 113. Accordingly, the fault management circuitry 218 identifies the severity threshold that corresponds to the type of fault. In some embodiments, the fault management circuitry 218 obtains the severity threshold from the NVM 106, such that information of the severity threshold is connected to the type of fault. In other embodiments, the fault management circuitry 218 determines the severity threshold based on an artificial intelligence (AI) engine, machine learning engine, and the like. For example, the AI engine is trained to determine the severity threshold over time based on type of fault that result in replacement. The two-column fault has more errors than can be fixed by the EC 111. Therefore, the fault management circuitry 218 indicates an RMA condition in the resolution table 230. That is, the fault management circuitry 218 indicates the DRAM 104 should be replaced. Under conventional solutions, the DRAM 104 employs page retirement for additional errors similar to the two-column fault and continues to do so until a replacement threshold is reached, such that the DRAM 104 is then replaced. In contrast, the fault management circuitry 218 indicates replacement earlier without waiting for the replacement threshold to be exceeded because the two-column fault already indicates the DRAM 104 is going to fail. Accordingly, future service disruptions to the GPU 102 can be avoided by predicting and preemptively replacing the faulty DRAM.

With respect to the partial-row fault, at the row 344, the fault examination circuitry 216 determined the memory bank 113 had a partial-row fault. The fault examination circuitry 216 identifies the memory bank 113 has one or more UEs in a single row. The examination circuitry 216 determines the EC 111 was unable to correct the one or more errors. Therefore, the fault management circuitry 218 stores information indicating page retirement in the resolution table 230. That is, the fault management circuitry 218 indicates the DRAM 104 is to redirect use of future memory access operations to a different and still operational area of the DRAM 104. However, unlike the previous example, the partial-row fault does not exceed the severity threshold. In response to determining the partial-row fault does not exceed the severity threshold, the fault management circuitry 218 stores an indication of page retirement as the management solution.

With respect to the single-row fault, at the row 345, the fault examination circuitry 216 determined the memory bank 113 had a single-row fault. The fault examination circuitry 216 identifies the memory bank 113 has one or more UEs in a single row. The examination circuitry 216 determines the EC 111 was unable to correct the one or more errors. Therefore, the fault management circuitry 218 identifies page retirement in the resolution table 230. That is, the fault management circuitry 218 indicates the DRAM 104 to redirect use of future memory access operations to a different and still operational area of the DRAM 104. The single-row fault does not exceed the severity threshold. In response to determining the single-row fault does not exceed the severity threshold, the fault management circuitry 218 stores an indication of page retirement as the management solution

With respect to the single-row-plus-single-bit fault, at the row 346, the fault examination circuitry 216 determined the memory bank 113 had a single-row-plus-single-bit fault. The fault examination circuitry 216 identifies the memory bank 113 has one or more UEs in a single row and a CE in another row. The examination circuitry 216 determines the EC 111 was unable to correct one or more errors, but was able to correct the single-bit error. Therefore, the fault management circuitry 218 identifies page retirement in the resolution table 230. That is, the fault management circuitry 218 indicates the DRAM 104 to redirect use of future memory access operations to a different and still operational area of the DRAM 104. The single-row-plus-single-bit fault does not exceed the severity threshold. In response to determining the single-row-plus-single-bit fault does not exceed the severity threshold, the fault management circuitry 218 stores an indication of page retirement as the management solution.

With respect to the two-row fault, at the row 347, the fault examination circuitry 216 determined the memory bank 113 had a two-row fault. The fault examination circuitry 216 identifies the memory bank 113 has one or more UEs in multiple rows. The examination circuitry 216 determines the EC 111 was unable to correct the one or more errors. Therefore, the fault management circuitry 218 identifies page retirement in the resolution table 230. That is, the fault management circuitry 218 indicates the DRAM 104 to redirect use of future memory access operations to a different and still operational area of the DRAM 104. The two-row fault does not exceed the severity threshold. In response to determining the two-row fault does not exceed the severity threshold, the fault management circuitry 218 stores an indication of page retirement as the management solution

With respect to the cluster-row fault, at the row 349, the fault examination circuitry 216 determined the memory bank 113 had a cluster-row fault. The fault examination circuitry 216 identifies the memory bank 113 has one or more UEs in multiple rows. The examination circuitry 216 determines the EC 111 was unable to correct the one or more errors. Therefore, the fault management circuitry 218 identifies page retirement in the resolution table 230. That is, the fault management circuitry 218 indicates the DRAM 104 to redirect use of future memory access operations to a different and still operational area of the DRAM 104. The cluster-row fault does not exceed the severity threshold. In response to determining the cluster-row fault does not exceed the severity threshold, the fault management circuitry 218 stores an indication of page retirement as the management solution

With respect to the single-bank fault, at the row 350, the fault examination circuitry 216 determined the memory bank 113 had a single-bank fault. The fault examination circuitry 216 identifies the memory bank 113 has one or more UEs in multiple banks of the DRAM 104. The examination circuitry 216 determines the EC 111 was unable to correct the one or more errors. The fault management circuitry 218 determines the single-bank fault exceeds the severity threshold to warrant a replacement. In other words, the single-bank fault has more errors than are able to be fixed by the EC 111. Therefore, the fault management circuitry 218 identifies RMA in the resolution table 230.

With respect to the quarter-device fault, at the row 351, the fault examination circuitry 216 determined the memory bank 113 had a quarter-device fault. The fault examination circuitry 216 identifies the memory bank 113 has one or more UEs in multiple banks of the DRAM 104. The examination circuitry 216 determines the EC 111 was unable to correct the one or more errors. The fault management circuitry 218 determines the quarter-device fault exceeds the severity threshold to warrant a replacement. In other words, the quarter-device fault has more errors than can be fixed by the EC 111. Therefore, the fault management circuitry 218 indicates an RMA condition in the resolution table 230.

With respect to the half-device fault, at the row 352, the fault examination circuitry 216 determined the memory bank 113 had a half-device fault. The fault examination circuitry 216 identifies the memory bank 113 has one or more UEs in multiple banks of the DRAM 104. The examination circuitry 216 determines the EC 111 was unable to correct the one or more errors. The fault management circuitry 218 determines the half-device fault exceeds the severity threshold to warrant a replacement. In other words, the half-device fault has more errors than can be fixed by the EC 111. Therefore, the fault management circuitry 218 identifies RMA in the resolution table 230.

With respect to the full-device fault, at the row 353, the fault examination circuitry 216 determined the memory bank 113 had a full-device fault. The fault examination circuitry 216 identifies the memory bank 113 has one or more UEs in multiple banks of the DRAM 104. The examination circuitry 216 determines the EC 111 was unable to correct the one or more errors. The fault management circuitry 218 determines the full-device fault exceeds the severity threshold to warrant a replacement. In other words, the full-device fault has more errors than can be fixed by the EC 111. Therefore, the fault management circuitry 218 identifies RMA in the resolution table 230.

With respect to the single-pin fault, at the row 354, the fault examination circuitry 216 determined the memory bank 113 had a single-pin fault. The fault examination circuitry 216 identifies the memory bank 113 has one or more UEs in multiple banks of the DRAM 104. The examination circuitry 216 determines the EC 111 was unable to correct the one or more errors. The fault management circuitry 218 determines the single-pin fault exceeds the severity threshold to warrant a replacement. In other words, the single-pin fault has more errors than can be fixed by the EC 111. Therefore, the fault management circuitry 218 identifies RMA in the resolution table 230.

With respect to the single-lane fault, at the row 355, the fault examination circuitry 216 determined the memory bank 113 had a single-lane fault. The fault examination circuitry 216 identifies the memory bank 113 has one or more UEs in multiple banks of the DRAM 104. The examination circuitry 216 determines the EC 111 was unable to correct the one or more errors. The fault management circuitry 218 determines the single-lane fault exceeds the severity threshold to warrant a replacement. In other words, the single-lane fault has more errors than can be fixed by the EC 111. Therefore, the fault management circuitry 218 identifies RMA in the resolution table 230.

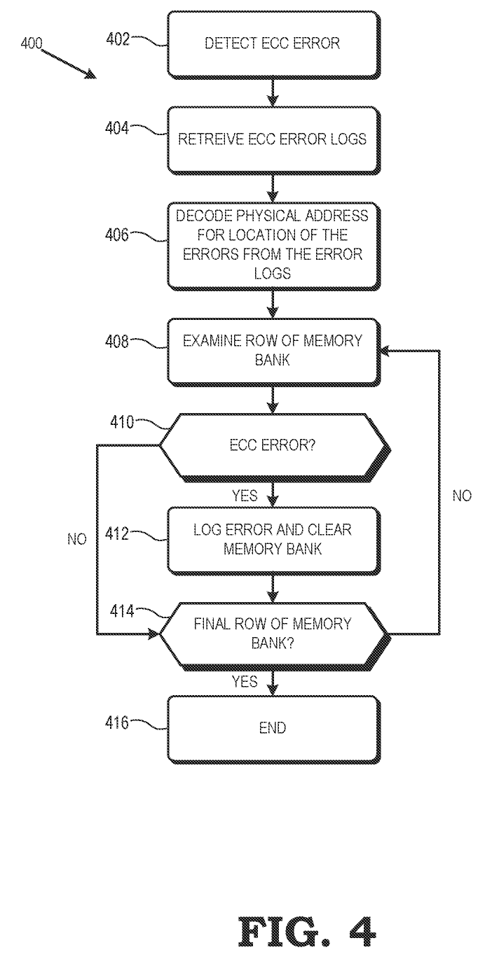

FIG. 4 illustrates a flow diagram illustrating a method 400 for examining the memory banks 113, 114 identified with errors in the one or more ECC logs 112 in accordance with some embodiments. The method 400 is described with respect to an example implementation of the processing system 100 of FIG. 1 and the fault analyzer circuitry 110 of FIG. 2. At block 402, the ECC of the EC circuitry 111 detects errors. At block 404, in response to detection of the errors by the ECC, the fault analyzer circuitry 110 retrieves all the errors recorded in the one or more ECC logs 112 on the NVM 106. At block 406, the fault analyzer circuitry 110 decodes the one or more ECC logs 112 to specifically identify one or more addresses and/or one or more memory banks 113, 114 in the DRAM 104 where the one or more errors occurred. At block 408, the fault analyzer circuitry 110 begins examining the memory banks 113, 114 containing the one or more errors after decoding the one or more ECC logs 112. At block 410, the fault analyzer circuitry 110 checks for the one or more ECC errors by testing the memory banks 113, 114 based on the one or more addresses identified in the one or more ECC logs 112. To test the memory banks 113, 114, the fault analyzer circuitry 110 initiates a memory access operation for each row in the memory banks 113, 114. If the fault analyzer circuitry 110 determined there was no error at a particular address, the procedure moves to block 414, which will be described further below. At block 412, the fault analyzer circuitry 110 logs any error encountered (e.g., in the resolution table 230) and confirmed to be an ECC error during examination in response to testing the memory banks 113, 114 (i.e., a register). The fault analyzer circuitry 110 clears the memory bank 113 or 114 in response to logging the error.

At block 414, the fault analyzer circuitry 110 checks whether the memory bank 113 or 114 is completed. Specifically, the fault analyzer circuitry 110 checks whether a final row of the memory bank 113 or 114 has been reached. If the final row in the memory bank 113 or 114 is not reached, the procedure returns to block 408 to continue examination. Accordingly, the fault analyzer circuitry 110 repeats the process for each other memory bank that was identified to have the one or more errors in the one or more ECC logs 112. At block 416, the fault analyzer circuitry 110 ends (i.e., completes) examination in response to reaching the final row in the memory bank 113 or 114. Furthermore, the fault analyzer circuitry 110 continues with construction of the resolution table 230 as described above.

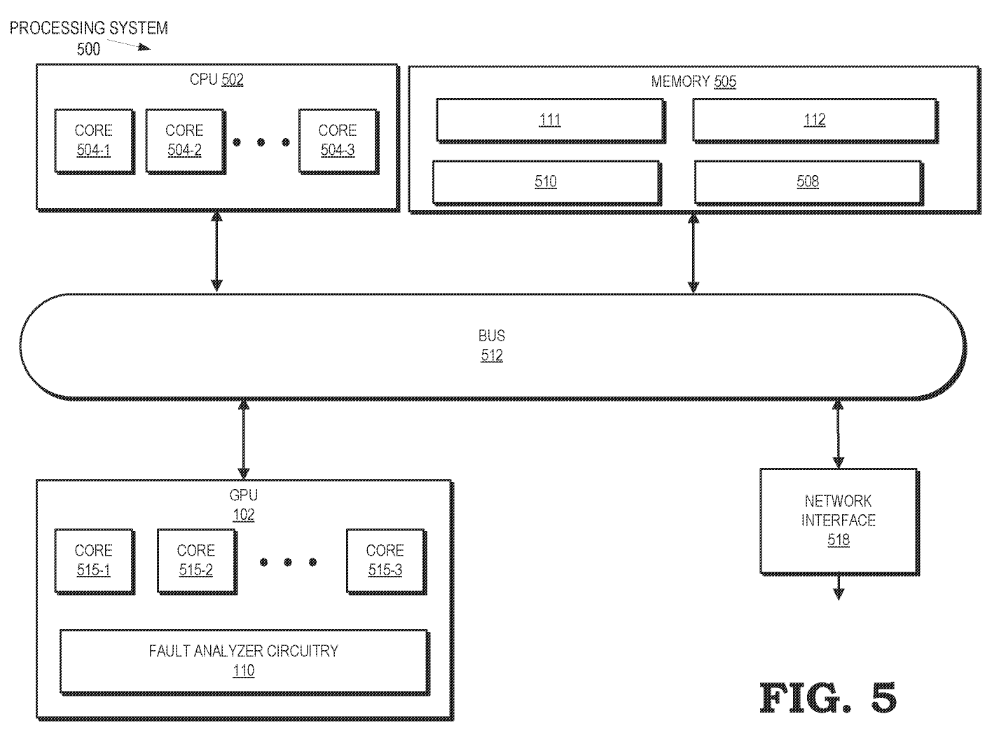

FIG. 5 illustrates an example of a processing system 500 that implements hardware memory fault analysis in accordance with some implementations. In some implementations, processing system 500 implements processing system 100 and employs a GPU 102 having fault analyzer circuitry that analyzes memory faults as described herein. To this end, processing system 500 includes or has access to memory 505 or another storage component implemented using a non-transitory computer-readable medium, for example, a dynamic random-access memory (DRAM). However, in some implementations, memory 505 is implemented using other types of memory including, for example, static random-access memory (SRAM), nonvolatile RAM, non-volatile memory 106, and the like, or a combination thereof. According to some implementations, memory 505 includes an external memory implemented external to the processing units implemented in processing system 500. Processing system 500 also includes bus 512 to support communication between entities implemented in processing system 500, such as memory 505. Some implementations of processing system 500 include other buses, bridges, switches, routers, and the like, which are not shown in FIG. 5 in the interest of clarity.

The techniques described herein are, in different implementations, employed at GPU 102. The GPU 102 includes, for example, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The GPU 102 renders graphics objects (e.g., sets of primitives) of a scene of a ray tracing context in a screen space (e.g., display space) to be displayed to produce values of pixels in the form of video frames, and the video frames are provided to a network interface 518 that communicates the video frames to the corresponding client devices via one or more networks. In some implementations, network interface 518 communicates with each client device via a respective network connection (not shown).

To render these graphics objects, the GPU 102 includes a plurality of processor cores 515-1 to 515-3 that execute instructions concurrently or in parallel. For example, the GPU 102 executes instructions from one or more graphics pipelines using a plurality of processor cores 515 to render one or more graphics objects. A graphics pipeline includes, for example, one or more steps, stages, or instructions to be performed by GPU 102 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 515 of GPU 102 in order to render one or more graphics objects for a scene.

In implementations, one or more processor cores 515 of GPU 102 each operate as a compute unit configured to perform one or more operations for one or more instructions received by GPU 102. These compute units each include one or more single instruction, multiple data (SIMD) units that perform the same operation on different data sets to produce one or more results. For example, GPU 102 includes one or more processor cores 515 each functioning as a compute unit that includes one or more SIMD units to perform operations for one or more instructions from a graphics pipeline. To facilitate one or compute units performing operations for instructions from a graphics pipeline, GPU 102 includes one or more command processors (not shown for clarity). Such command processors, for example, include hardware-based circuitry, software-based circuitry, or both configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG.5 presents GPU 102 as having three processor cores (515-1, 515-2, 515-3) representing an arbitrary number of cores; the number of processor cores 515 implemented in GPU 102 is a matter of design choice. As such, in other implementations, GPU 102 includes any number of processor cores 515. Some implementations of GPU 102 are used for general-purpose computing. For example, GPU 102 executes instructions such as program code 508 for one or more applications 510 stored in memory 505 and GPU 102 stores information in the memory 505 such as the results of the executed instructions. Memory 505 also stores ECC logs 112 for use in fault analysis operations as described herein.

In some implementations, the GPUs 102 is configured to perform graphics operations. To facilitate the performance of such operations, each graphics core of GPU 102 (e.g., configured to communicate with) a respective command processor configured to provide data (e.g., operations, operands, instructions, variables, register files) to one or more compute units of a graphics core necessary for, helpful for, or aiding in the performance of the operations for a respective set of instructions. Because each graphics core is associated with a respective command processor configured to provide data based on a respective set of instructions, the graphics cores are enabled to render different graphics objects and encode different portions of an image at different times. Because each graphics core is associated with a respective command processor configured to provide data based on a respective set of instructions, the graphics cores are enabled to render different graphics objects at different times. That is to say, two or more graphics cores are configured to concurrently render different graphics objects such that, for example, a first graphics core renders a first graphics object, and a second graphics core concurrently renders a second graphics object different from the first graphics object. In some cases, two or more graphics cores are configured to concurrently render different graphics objects of a same ray tracing context for different client devices.

The GPU 102 includes fault analyzer circuitry 110 that performs fault analysis operations as described further herein. For example, in some embodiments the fault analyzer circuitry 110 analyzes the ECC logs 112, as generated by the ECC circuitry 111, to identify specific portions of the memory 505 where errors were detected. Moreover, the fault analyzer circuitry 110 checks each memory bank in the memory 505 to determine the extent of the errors. Once all the memory banks of the memory 505 have been identified from the error logs 112, the fault analyzer circuitry 110 classifies the fault mode of the DRAM based on a type and a number of the errors. The fault analyzer circuitry 110 further generates a recommended the solution for fault management of the memory 505. For example, in some embodiments the fault analyzer circuitry 110 recommends page retirement for minor errors, and recommends hardware replacement for severe errors (e.g., multiple errors in multiple addresses of the memory 505).

Processing system 500 also includes a central processing unit (CPU) 502 that is connected to bus 512 and communicates with the GPUs 102 and 104 and memory 505 via bus 512. CPU 502 includes a plurality of processor cores 504-1 to 504-3 that execute instructions concurrently or in parallel. Though in the example implementation illustrated in FIG. 5, three processor cores (504-1, 504-2, 504-3) are presented representing an arbitrary number of cores, the number of processor cores 504 implemented in the CPU 502 is a matter of design choice. As such, in other implementations, the CPU 502 can include any number of processor cores 504. In some implementations, the CPU 502 and GPUs 102 and 104 have an equal number of processor cores while in other implementations, the CPU 502 and GPUs 102 and 104 have differing numbers of processor cores. Processor cores 504 execute instructions such as program code 508 for one or more applications 510 stored in memory 505 and CPU 502 stores information in the memory 505 such as the results of the executed instructions. CPU 502 is also able to initiate graphics processing, including one or more encoding operations, by issuing commands (e.g., encoding commands, draw calls, and the like) to GPU 102 via bus 512.

In some embodiments, the apparatus and techniques described above are implemented in a system including one or more integrated circuit (IC) devices (also referred to as integrated circuit packages or microchips), such as the processing system 100 described above with reference to FIG. 1. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
determining, by a fault analyzer circuitry, a fault mode for at least one memory bank based on one or more error correction code (ECC) errors identified in an error log associated with at least one memory bank; and
generating a recommended management solution for the at least one memory bank in response to the fault mode.

2. The method of claim 1, wherein the recommended management solution is at least one of logging the one or more ECC errors, retiring a memory page, and recording a return merchandise authorization.

3. The method of claim 1, wherein determining the fault mode further comprises:
testing at least one cell of the memory bank to determine an ECC error.

4. The method of claim 3, further comprising:
logging the ECC error; and
clearing the at least one memory bank in response to identifying the ECC error.

5. The method of claim 1, wherein generating the recommended management solution comprises:
predicting a failure rate of the at least one memory bank based on the fault mode, wherein the failure rate is indicated by a predetermined set of data based on occurrence of the fault mode.

6. The method of claim 5, wherein predicting the failure rate comprises predicting the failure rate based on a specified set of failure rates for memory banks.

7. The method of claim 1, wherein determining the fault mode comprises:
retrieving an address from the error log; and
decoding the address into at least one of channel, bank, and row associated with the at least one memory bank.

8. A processing system, comprising:
a processor connected to a memory unit and configured to:
identify one or more error correction code (ECC) errors based on error logs to determine a fault mode of at least one memory bank; and
store a recommended management solution for the at least one memory bank based on the fault mode.

9. The processing system of claim 8, wherein the recommended management solution is at least one of logging the one or more ECC errors, retiring a memory page, and recording a return merchandise authorization.

10. The processing system of claim 8, wherein the processor is further configured to:
test at least one cell of the memory bank to determine the fault mode to identify the ECC error.

11. The processing system of claim 10, wherein the processor is further configured to:
log the ECC error; and
clear the at least one memory bank in response to identifying the at least one memory bank has the ECC error.

12. The processing system of claim 10, wherein the processor is further configured to:
disable system interrupt handlers in response to testing the at least one memory bank.

13. The processing system of claim 8, wherein the processor is further configured to:
predict a failure rate of the memory unit based on the fault mode.

14. The processing system of claim 8, wherein the processor is further configured to:
retrieve an address from the error logs; and
decode the address into at least one of channel, bank, and row.

15. A method, comprising:
testing at least one memory bank of a dynamic random-access memory (DRAM) identified in error logs to determine a fault mode of the at least one memory bank; and
storing a recommended management solution for the at least one memory bank in response to the fault mode.

16. The method of claim 15, wherein testing the at least one memory bank comprises:
performing at least one of a read operation and a write operation for each row of the memory bank.

17. The method of claim 16, further comprising:
disabling system interrupt handlers in response to performing at least one of the read operation and the write operation.

18. The method of claim 15, further comprising:
prior to retrieving the error logs from the DRAM, resetting a processing unit associated with the DRAM.

19. The method of claim 15, wherein the management solution is based on a number uncorrectable errors at the memory bank.

20. The method of claim 15, further comprising:
predicting a failure rate of DRAM based on the fault mode.
